(19) United States
(12) Patent Application Publication
(10) Pub. No.: US 2014/0297844 A1
(43) Pub. Date: Oct. 2, 2014

(54) Application Traffic Prioritization

(71) Applicant: Brocade Communications Systems, Inc., San Jose, CA (US)

(72) Inventors: Mani Kancherla, Cupertino, CA (US); Sam Moy, San Jose, CA (US); Venkata Nambula, San Jose, CA (US)

(73) Assignee: Brocade Communications Systems, Inc., San Jose, CA (US)

(21) Appl. No.: 14/191,007

(22) Filed: Feb. 26, 2014

Related U.S. Application Data
(60) Provisional application No. 61/874,193, filed on Sep. 5, 2013.
(60) Provisional application No. 61/856,469, filed on Jul. 19, 2013.
(60) Provisional application No. 61/806,668, filed on Mar. 29, 2013.

(51) Int. Cl. H04L 12/26; H04L 12/835

(52) U.S. Cl. CPC H04L 43/0894; H04L 47/30
USPC 709/224

(57) ABSTRACT

Techniques for implementing application traffic prioritization in a network device are provided. In one embodiment, the network device can determine a packet buffer threshold for a received data packet. The network device can further compare the packet buffer threshold with a current usage of a packet buffer memory that stores data for data packets to be forwarded to a processing core of the network device. If the current usage of the packet buffer memory exceeds the packet buffer threshold, the network device can perform an action on the received data packet.

### CROSS REFERENCES TO RELATED APPLICATIONS

The present application claims the benefit and priority under 35 U.S.C. 119(e) of U.S. Provisional Application No. 61/806,668, filed Mar. 29, 2013, entitled “HARDWARE-ASSISTED APPLICATION TRAFFIC PRIORITIZATION”; U.S. Provisional Application No. 61/856,469, filed Jul. 19, 2013, entitled “APPLICATION TRAFFIC PRIORITIZATION”; and U.S. Provisional Application No. 61/874,193, filed Sep. 5, 2013, entitled “APPLICATION TRAFFIC PRIORITIZATION.” The entire contents of these provisional applications are incorporated herein by reference for all purposes.

### BACKGROUND

Application delivery controllers (ADCs), also known as Layer 4-7 switches or application delivery switches, are network devices that optimize the delivery of cloud-based applications to client devices. For example, ADCs can provide functions such as server load balancing, TCP connection management, traffic redirection, automated failover, data compression, network attack prevention, and more. In a typical data center environment, an ADC is configured to host multiple virtual IP addresses (VIPs), where each VIP corresponds to an application or service that is offered by one or more application servers in the data center. When the ADC receives a client request directed to a particular VIP, the ADC executes the functions defined for the VIP and subsequently forwards the client request (if appropriate) to one of the application servers for request processing.

In recent years, ADCs have increasingly become exposed to high rate, distributed denial-of-service (DDoS) attacks that target specific VIPs/applications. These attacks are referred to as application-layer, or Layer 7, DDoS attacks. In such an attack, malicious clients transmit a large number of “phony” request packets to a targeted VIP over a relatively short period of time, thereby causing the receiving ADC to become overloaded and unresponsive. In many cases, the phony request traffic can tie up the resources of the ADC to the extent that all of the VIPs configured on the ADC (i.e., both targeted and un-targeted VIPs) are rendered inaccessible. This “spillover” effect across VIPs can cause significant problems in environments (such as the data center environment noted above) where an ADC may host many VIPs concurrently.

### SUMMARY

Techniques for implementing application traffic prioritization in a network device are provided. In one embodiment, the network device can determine a packet buffer threshold for a received data packet. The network device can further compare the packet buffer threshold with a current usage of a packet buffer memory that stores data for data packets to be forwarded to a processing core of the network device. If the current usage of the packet buffer memory exceeds the packet buffer threshold, the network device can perform an action on the received data packet.

The following detailed description and accompanying drawings provide a better understanding of the nature and advantages of particular embodiments.

### BRIEF DESCRIPTION OF DRAWINGS

FIG. 1 depicts a system environment according to an embodiment.

FIG. 2 depicts a network switch according to an embodiment.

FIG. 3 depicts an exemplary list of priority levels according to an embodiment.

FIG. 4 depicts a flowchart for processing an incoming data packet according to an embodiment.

FIG. 5 depicts an exemplary VIP table according to an embodiment.

FIG. 6 depicts a flowchart for assigning a lower priority level to a VIP according to an embodiment.

FIG. 7 depicts another exemplary VIP table according to an embodiment.

FIG. 8 depicts a flowchart for assigning a higher priority level to a VIP according to an embodiment.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details, or can be practiced with modifications or equivalents thereof.

Embodiments of the present invention provides techniques for implementing application traffic prioritization in a network device, such as an ADC. In one set of embodiments, a priority level can be assigned to each VIP configured on the network device, where the priority level maps to a threshold for a packet buffer memory that the network device uses for temporarily holding data packets to be forwarded to the device's processing core(s). In a particular embodiment, higher priority levels can map to higher packet buffer thresholds while lower priority levels can map to lower packet buffer thresholds.

When the network device receives a data packet that is destined for a VIP and that should be forwarded to a processing core, prioritization logic within the network device can identify the packet buffer threshold mapped to the VIP's assigned priority level and can compare the packet buffer threshold with the current usage of the packet buffer memory. The usage of the packet buffer memory can be considered a proxy for the load of the network device (e.g., higher usage indicates higher device load, lower usage indicates lower device load). The prioritization logic can then drop the data packet if the current usage of the packet buffer memory exceeds the determined packet buffer threshold. In this manner, the network device can prioritize incoming data traffic on a per VIP basis such that, when the network device is under load (i.e., the packet buffer memory is close to full), traffic directed to VIPs with a lower priority level (and thus a lower packet buffer threshold) will be dropped with greater probability/frequency than traffic directed to VIPs with a higher priority level (and thus a higher packet buffer threshold).

In certain embodiments, the prioritization logic can be implemented in a component that is distinct from the network device's processing core(s). For example, the prioritization logic can be implemented in a distinct field-programmable gate array (FPGA), a distinct application-specific integrated circuit (ASIC), or as software that runs on a distinct general purpose CPU. By keeping the prioritization logic separate from the network device's processing core(s), embodiments of the present invention can avoid consuming packet buffer memory and processing core resources on data packets that will be dropped.

In further embodiments, concurrently with the prioritization processing described above, the network device can dynamically change the priority level for each VIP based on real-time changes in the VIP's connection rate (e.g., connections/second). For instance, when the network device detects that the connection rate for the VIP has climbed above a predefined rate threshold, the network device can reduce the VIP's priority level, and when network device detects that the connection rate has fallen back below the predefined rate threshold, the network device can increase the VIP's priority level again. Among other things, this allows the network device to isolate the effects of high rate, Layer 7 DDoS attacks. For example, assume that VIP A comes under attack, such that a large number of connections to VIP A are created by malicious clients within a short period of time. In this scenario, the network device can detect that the connection rate for VIP A has exceeded its predefined rate threshold and can reduce the priority level for VIP A. This, in turn, can cause the prioritization logic to drop VIP A's traffic with greater frequency/probability than before, thereby reserving more resources for processing traffic directed to the other, non-targeted VIPs hosted on the network device.

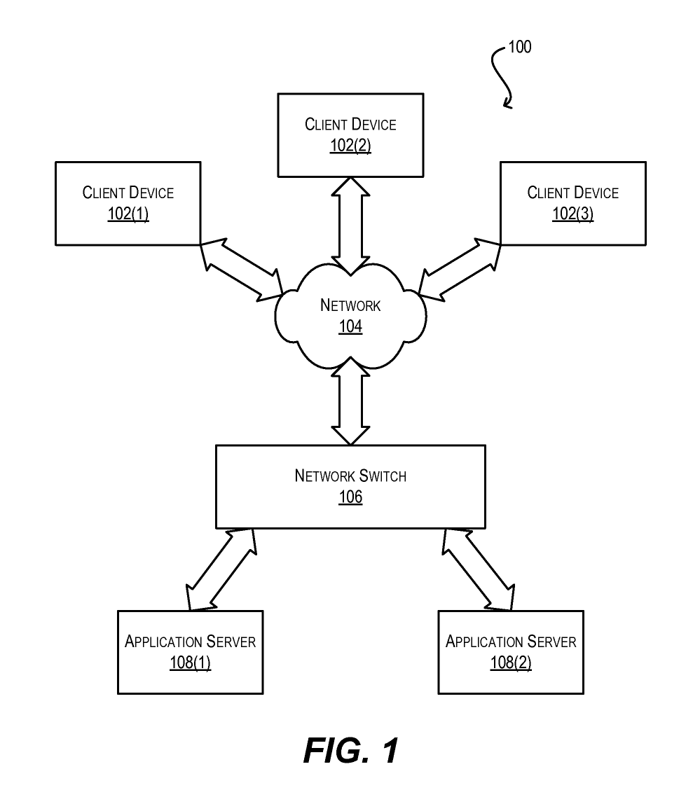

FIG. 1 depicts a system environment 100 according to an embodiment. As shown, system environment 100 includes a number of client devices 102(1), 102(2), and 102(3) that are communicatively coupled with application servers 108(1) and 108(2) through a network 104 and a network switch 106. Although FIG. 1 depicts three client devices, two application servers, and one network switch, any number of these entities may be supported.

Client devices 102(1)-102(3) can be end-user computing devices, such as desktop computers, laptop computers, personal digital assistants, smartphones, tablets, or the like. In one embodiment, client devices 102(1)-102(3) can each execute (via, e.g., a standard web browser or proprietary software) a client component of a distributed software application hosted on application servers 108(1) and/or 108(2), thereby enabling users of client devices 102(1)-102(3) to interact with the application.

Application servers 108(1) and 108(2) can be physical computer systems (or clusters/groups of computer systems) that are configured to provide an environment in which the server component of a distributed software application can be executed. For example, application server 108(1) or 108(2) can receive a request from client device 102(1), 102(2), or 102(3) that is directed to an application hosted on the server, process the request using business logic defined for the application, and then generate information responsive to the request for transmission to the client device. In embodiments where application servers 108(1) and 108(2) are configured to host one or more web applications, application servers 108(1) and 108(2) can interact with one or more web server systems (not shown). These web server systems can handle the web-specific tasks of receiving Hypertext Transfer Protocol (HTTP) requests from client devices 102(1)-102(3) and servicing those requests by returning HTTP responses.

Network switch 106 is a network device that can receive and forward data packets to facilitate delivery of the data packets to their intended destinations. In a particular embodiment, network switch 106 can be an ADC, and thus can perform various Layer 4-7 functions to optimize and/or accelerate the delivery of applications from application servers 108(1)-108(2) to client devices 102(1)-102(3). In certain embodiments, network switch 106 can also provide integrated Layer 2/3 functionality.

To support the foregoing features, network switch 106 can be configured with one or more VIPs that correspond to the applications hosted on application servers 108(1) and 108(2), as well as the IP addresses of servers 108(1) and 108(2). Upon receiving a data packet from a client device that is destined for a particular VIP, network switch 106 can perform appropriate Layer 4-7 processing on the data packet, change the destination IP address of the packet from the VIP to the IP address of one of the application servers via network address translation (NAT), and then forward the packet to the selected application server. Conversely, upon intercepting a reply data packet from an application server that is destined for a client device, network switch 106 can perform appropriate Layer 4-7 processing on the reply data packet, change the source IP address of packet from the application server IP address to the VIP via NAT, and then forward the packet to the client device.

It should be appreciated that system environment 100 is illustrative and is not intended to limit embodiments of the present invention. For example, the various entities depicted in system environment 100 can have other capabilities or include other components that are not specifically described. One of ordinary skill in the art will recognize many variations, modifications, and alternatives.

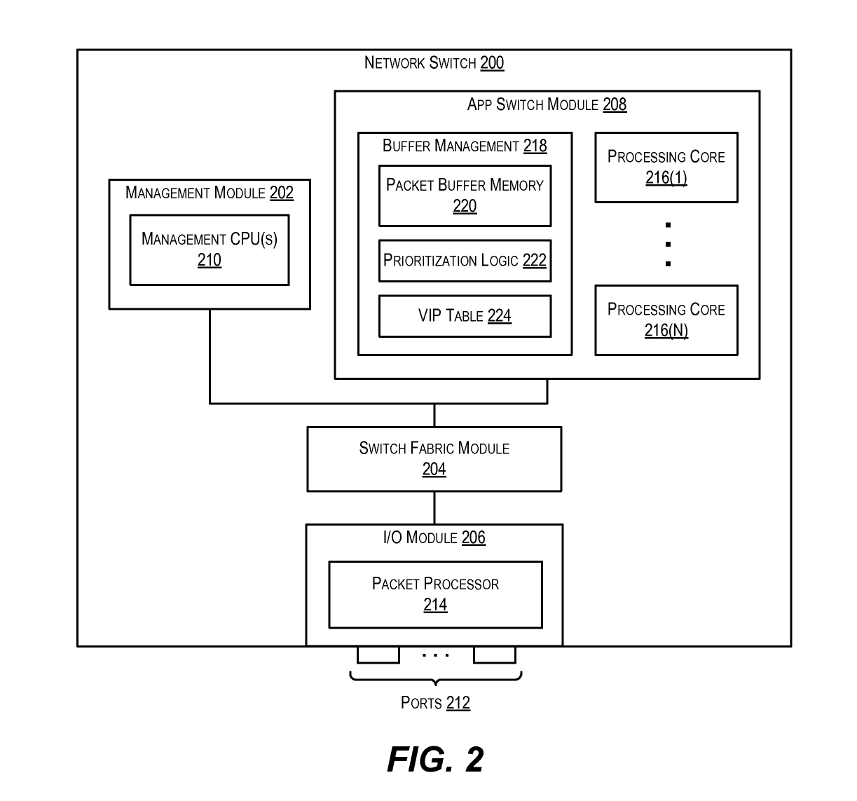

FIG. 2 depicts an exemplary network switch 200 that can be used to implement switch 106 of FIG. 1 according to an embodiment. As shown, network switch 200 includes a management module 202, a switch fabric module 204, an I/O module 206, and an application switch module 208. Although FIG. 2 illustrates one of each module 202-208, any number of these modules can be supported. For example, in a particular embodiment, each module 202-208 can be implemented as a blade that is insertable into (and removable from) one of a plurality of modular slots in the chassis of network switch 200. In this manner, network switch 200 can be flexibly configured to accommodate different network topologies and switching requirements.

Management module 202 represents the control plane of network switch 200 and thus includes one or more management CPUs 210 for managing/controlling the operation of the switch. Each management CPU 210 can be a general purpose processor, such as a PowerPC, Intel, AMD, or ARM-based processor, that operates under the control of software stored in an associated memory (not shown).

Switch fabric module 204, I/O module 206, and application switch module 208 collectively represent the data, or forwarding, plane of network switch 200. Switch fabric module 204 interconnects I/O module 206, application switch module 208, and management module 202. I/O module 206 (also known as a linecard) includes one or more input/output ports 212 for receiving/transmitting data packets and a packet processor 214 for determining how those data packets should be forwarded. For instance, in one embodiment, packet processor 214 can determine that an incoming data packet should be forwarded to application switch module 208 for, e.g., Layer 4-7 processing.

Application switch module 208 can be considered the main processing component of network switch 200. As shown, application switch module 208 includes a plurality of processing cores 216(1)-216(N). Like management CPU(s) 210, each processing core 216(1)-216(N) can be a general purpose processor (or a general purpose core within a multi-core processor) that operates under the control of software stored in an associated memory (not shown). In various embodiments, processing cores 216(1)-216(N) can execute the Layer 4-7 functions attributed to network switch 106 of FIG. 1.

Application switch module 208 also includes a buffer management component 218 that is distinct from processing cores 216(1)-216(N). In one embodiment, buffer management component 218 can be implemented in hardware as an FPGA or ASIC. In other embodiments, buffer management component 218 can correspond to software that runs on a general purpose processor. In operation, buffer management component 218 can intercept data packets that are forwarded by packet processor 214 to processing cores 216(1)-216(N) and can temporarily store data for the data packets in a packet buffer memory 220 (e.g., a FIFO queue). In this way, buffer management component 218 can regulate the flow of data packets from packet processor 214 to processing cores 216(1)-216(N). Once a particular data packet has been added to packet buffer memory 220, the data packet can wait in turn until one of the processing cores is ready to handle the packet.

In existing ADCs, packet buffer memory 220 is typically a “global” buffer that is shared among all processor cores 216(1)-216(N) and all VIPs configured on the ADC. In other words, packet buffer memory 220 temporarily holds data for all data packets that are forwarded by packet processor 214 to processing cores 216(1)-216(N), regardless of the processing core or the packet's destination VIP. In cases where a particular VIP is targeted by a high rate DDoS attack (or otherwise experiences an unexpected surge in traffic), this configuration can lead to a “spillover” effect that negatively impacts the other, non-targeted VIPs.

For example, assume network switch 200 hosts VIPs A, B, and C, and that VIP A comes under attack. In this scenario, packet buffer memory 220 can become saturated with phony request packets directed to VIP A, to the extent that there is no further room in packet buffer memory 220 for legitimate traffic directed to VIPs B and C. As a result, network switch 200 may begin dropping VIP B/C traffic (and thus cause the applications corresponding to VIPs B and C to become unresponsive or unavailable), even though VIPs B and C are not directly under attack.

To address this problem (and other similar problems), network switch 200 can include a prioritization logic component 222 and a VIP table 224. Although prioritization logic 222 and VIP table 224 are shown in FIG. 2 as being part of buffer management component 218, in alternative embodiments these entities can be implemented at other locations in the data path between packet processor 214 and processing cores 216(1)-216(N).

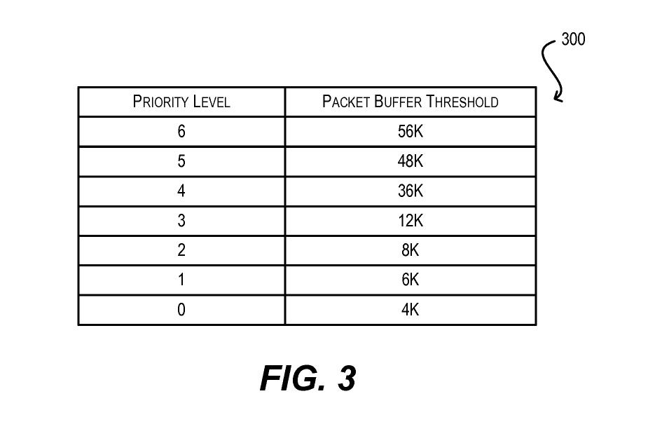

In various embodiments, VIP table 224 can store priority levels assigned to the VIPs configured on network switch 200, where each priority level maps to a threshold for packet buffer memory 220. For instance, FIG. 3 depicts an exemplary set of mappings (300) between priority levels 6-0 and packet buffer thresholds 56K, 48K, 36K, 12K, 8K, 6K, and 4K respectively. In this example, each packet buffer threshold represents a number of used entries in packet buffer memory 220.

When packet processor 214 forwards a data packet to a core 216(1)-216(N) for processing, prioritization logic 222 can determine the VIP to which the packet is directed and retrieve the VIP's assigned priority level from VIP table 224. Prioritization logic 222 can then compare the packet buffer threshold for the VIP's priority level against the current usage of packet buffer memory 220. If the current usage exceeds the packet buffer threshold, prioritization logic 222 can cause network switch 200 to drop the data packet, such that it never reaches any processing core 216(1)-216(N). On the other hand, if the current usage of packet buffer memory 220 does not exceed the packet buffer threshold, prioritization logic 222 can allow data for the data packet to be added to packet buffer memory 220 (and thereafter passed to a processing core 216(1)-216(N)).

Concurrently with the above, processing cores 216(1)-216(N) (or another processing component of network switch 200, such as management CPU(s) 210) can continuously monitor, in real-time, the connection rates for each VIP. If the connection rate for a particular VIP exceeds a predefined rate threshold for the VIP (signaling a possible high rate DDoS attack), the processing core can program a new, lower priority level for the VIP into VIP table 224. This, in turn, will cause prioritization logic 222 to drop incoming data packets for the VIP with a higher probability/frequency than before, since the lower priority level will be mapped to a lower packet buffer threshold.

Significantly, lowering the priority level for the VIP in this manner will improve the ability of network switch 200 to service other VIPs configured on the switch, because the other VIPs will now have a greater number of packet buffer memory entries “reserved” for their traffic. In a Layer 7 DDoS attack scenario, this can essentially isolate the effects of the attack from non-targeted VIPs, and thus can allow network switch 200 to continue servicing the non-targeted VIPs without interruption.

By way of example, assume that network switch 200 is configured to host two VIPs A and B, where each VIP is initially assigned a priority level of 6 (which corresponds to a packet buffer threshold of 56K entries per FIG. 3). Further assume that, at some point during the operation of network switch 200, VIP A is targeted by a high rate DDoS attack.

In response, one of the processing cores 216(1)-216(N) can detect the attack (by, e.g., comparing the connection rate for VIP A against a predefined rate threshold) and can program a lower priority level (e.g., level 3) for VIP A into VIP table 224. Since priority level 3 maps to a lower packet buffer threshold (12K entries) than initial priority level 6 (56K entries), prioritization logic 222 will drop VIP A's traffic sooner than before (i.e., when the buffer usage reaches 12k entries, rather than 56K entries). This means that an additional 44K entries are now “reserved” for solely VIP B, which should be enough to service all of VIP B's normal traffic. Thus, VIP B is shielded from the attack against VIP A.

It should be noted that, in addition to isolating the effects of Layer 7 DDoS attacks, the prioritization techniques described with respect to FIG. 2 can also maximize the utilization of network switch 200 when, e.g., switch 200 is lightly loaded. For example, in some cases, a spike in the connection rate for a given VIP may not be caused by a DDoS attack, but instead may be caused by a legitimate surge in client traffic. In these situations, it would be preferable to allow as much traffic for the VIP as possible, as long as network switch 200 does not become overloaded.

The design of prioritization logic 222 can accommodate this, since the usage of packet buffer memory 220 (which determines whether a given data packet is dropped or not) will inherently vary depending on the load on network switch 200. For instance, in the example above concerning VIPs A and B, assume that network switch 200 receives very little traffic directed to VIP B. In this scenario, even if the priority level for VIP A is reduced from 6 to 3 (due to an increase in VIP A's connection rate), network switch 200 may still be able to accept all of VIP A's traffic because processing cores 216(1)-216(N) are lightly loaded (and thus can process VIP's A packets quickly enough to keep the usage of packet buffer memory 220 below the lower threshold of 12K entries). As VIP B receives more and more traffic, the threshold of 12K entries will likely eventually be reached, at which point network switch 200 will begin to drop VIP A traffic.

The foregoing means that the packet buffer thresholds used by prioritization logic 222 place flexible, rather than hard, limits on the amount of data that network switch 200 will accept for a given VIP—in other words, the packet buffer thresholds will allow more or less VIP traffic depending on how loaded the switch is (as reflected by packet buffer memory usage). This is in contrast to prior art rate limiting techniques, which impose “hard caps” on the number of data packets that a network device will accept from a given source IP address (or for a given destination IP address), regardless of the load on the device.

Given this characteristic, one potential use case for the prioritization techniques described above (beyond Layer 7 DDoS attack mitigation) is in the field of network infrastructure provisioning. For instance, assume an infrastructure provider that operates network switch 200 wishes to sell bandwidth on a per-VIP basis to application vendors/providers. The infrastructure provider can offer, e.g., three different tiers of service (100 connections/sec, 1000 connections/sec, 1,000,000 connections/sec) that each has a different price and can allow an application provider to choose one. The infrastructure provider can then set the connection rate threshold for that application provider's VIP to the selected tier and allow the application/VIP to operate.

If the traffic destined for the VIP never exceeds the agreed-upon connection rate, the application will not experience any dropped packets. If the traffic destined for the VIP does exceed the agreed-upon connection rate, the priority level (and packet buffer threshold) for the VIP will be lowered. This may, or may not, result in dropped packets, because the packet buffer threshold is compared against the packet buffer memory usage (i.e., current load) of network switch 200. If network switch 200 is heavily loaded (i.e., has high packet buffer memory usage), it is more likely that the VIP's traffic will be dropped. However, if network switch 200 is not heavily loaded (i.e., has low packet buffer memory usage), it is possible that network switch 200 can absorb all of the excess traffic for the VIP (since the buffer queue will never fill up a substantial amount).

The scenario above means that the infrastructure provider can allow the application provider to consume more bandwidth than the agreed-upon rate if network switch 200 can support it. The infrastructure provider can then track this “over-usage” and charge the application provider for a higher service tier accordingly. This approach is preferable over applying pure rate limiting on the connection rate for a given VIP, since it is in the infrastructure provider's financial interest to allow “over-usage” whenever possible (i.e., in cases where network switch 200 is lightly loaded).

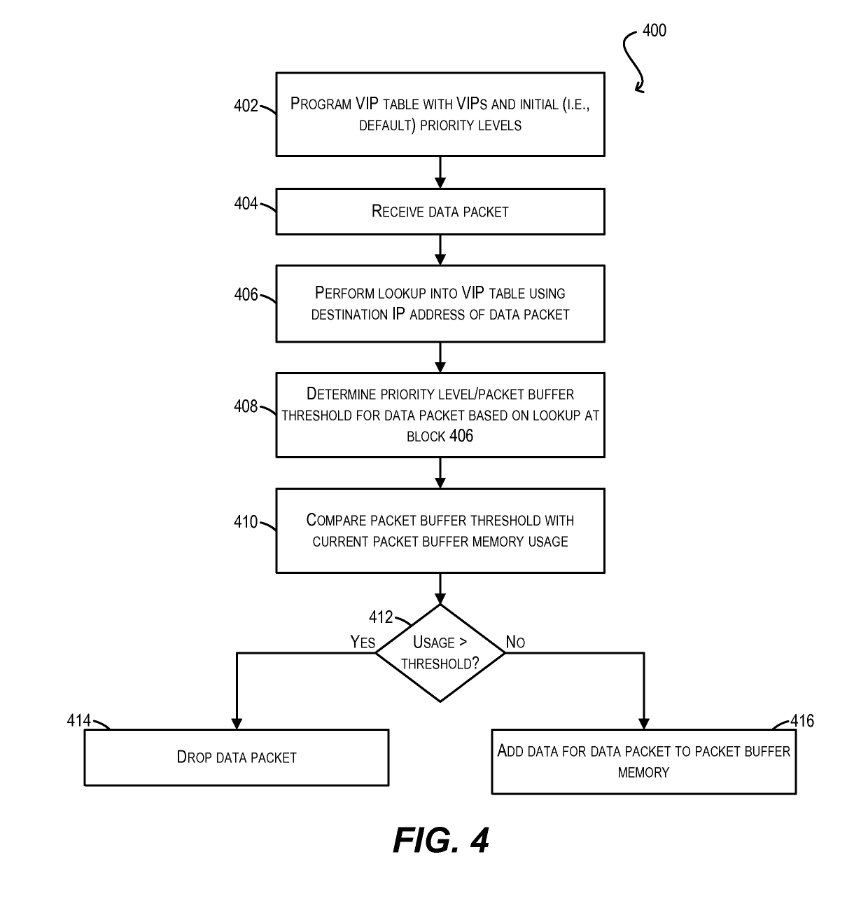

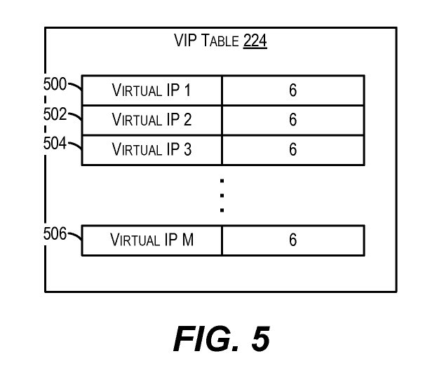

FIG. 4 depicts a flowchart 400 that describes, in further detail, the processing that can be performed by prioritization logic 222 of network switch 200 for prioritizing an incoming data packet. At block 402, VIP table 224 of network switch 200 can be programmed with an initial (i.e., default) priority level for each VIP configured on the switch. As noted previously, each priority level can map to a packet buffer threshold for packet buffer memory 220. For instance, FIG. 5 illustrates an exemplary version of VIP table 224 that has been programmed with M VIP entries 502-506 (for VIPs 1-M), where each VIP entry is initialized with a default priority level of 6. In one embodiment, these default priority levels can be specified manually by, e.g., an administrator of network switch 200. In other embodiments, these default priority levels can be automatically set by, e.g., management CPU 210 as part of an initialization/boot-up phase of switch 200.

At block 404, network switch 200 can receive a data packet that is destined for a VIP and that needs to be forwarded to a processing core 216(1)-216(N). In response, prioritization logic 222 can perform a lookup into VIP table 224 using the packet's destination IP address (i.e., the VIP) in order to determine the appropriate priority level for prioritizing the data packet (block 406).

Assuming the VIP exists in VIP table 224, prioritization logic 222 can retrieve the VIP's priority level from VIP table 224 based on the lookup at block 406 and can determine the corresponding packet buffer threshold (block 408). Prioritization logic 222 can then compare the packet buffer threshold with the current usage of packet buffer memory 220 (block 410).

If the current usage exceeds the packet buffer threshold, prioritization logic 222 can drop the data packet (blocks 412, 414). On the other hand, if the current usage does not exceed the packet buffer threshold, prioritization logic 222 can add data for the data packet to packet buffer memory 220 (thereby allowing the data packet to be processed by a processing core 216(1)-216(N)) (block 416).

It should be appreciated that, while flowchart 400 assumes the packet buffer threshold mapped to each priority level is a “usage” threshold, in other embodiments each packet buffer threshold may be a “free space” threshold. For example, priority level 6 may map to a free space threshold of 8K entries (which is identical to a usage threshold of 56K entries if the total size of packet buffer memory 220 is 64K entries). In these embodiments, the comparison performed at blocks 410, 412 can be modified such that prioritization logic 222 compares the amount of free space in packet buffer memory 220 against the free space threshold, rather than the usage of packet buffer memory 220 against a usage threshold.

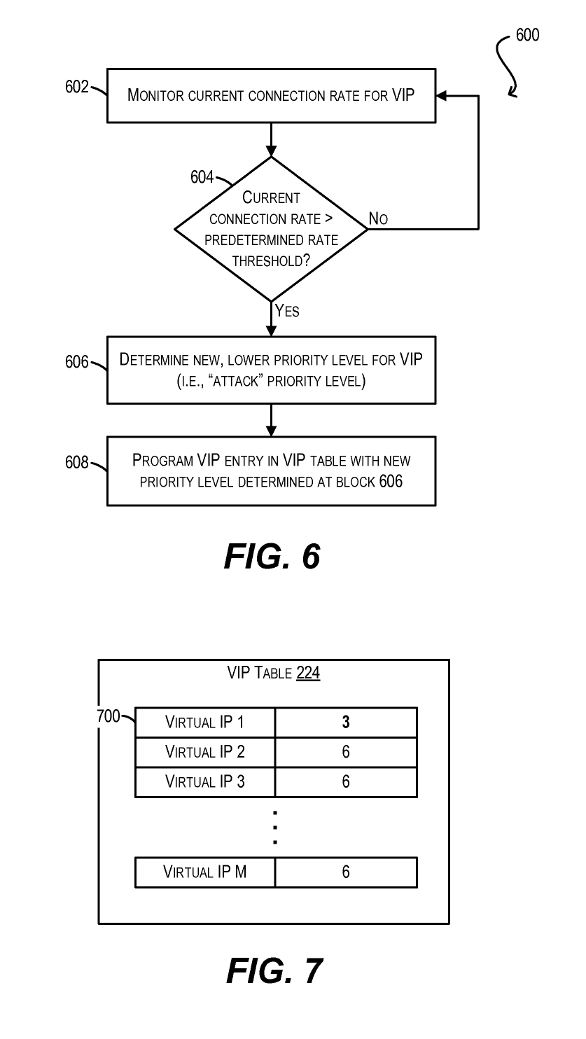

FIG. 6 depicts a flowchart 600 that describes, in further detail, the processing that can be performed by, e.g., a processing core 216(1)-216(N) of network switch 200 for dynamically lowering a VIP priority level. In various embodiments, flowchart 600 can be performed in tandem with flowchart 400 of FIG. 4.

At block 602, processing core 216(1)-216(N) can monitor the current connection rate for a given VIP (e.g., VIP 1 shown in FIG. 5). For instance, processing core 216(1)-216(N) can update the connection rate for VIP 1 each time it receives a data packet directed to VIP 1 for processing.

At block 604, processing core 216(1)-216(N) can compare the current connection rate against a predefined rate threshold for VIP 1. Like the default priority levels described with respect to block 402 of FIG. 4, the predefined rate threshold can be specified manually by an administrator/user or determined automatically by network switch 200. If the current connection rate does not exceed the predefined rate threshold, process 600 can return to block 602 and processing core 216(1)-216(N) can continue to monitor the connection rate for VIP 1.

On the other hand, if the current connection rate does exceed the predefined rate threshold, processing core 216(1)-216(N) can determine a new, lower priority level for VIP 1 (i.e., an “attack” priority level) (block 606). The lower priority level can map to a lower buffer queue threshold than the previous, default priority level. Processing core 216(1)-216(N) can then program the entry for VIP 1 in VIP table 224 with the lower priority level determined at block 606 (block 608). For example, FIG. 7 depicts a modified version of VIP table 224 that shows the priority level for VIP 1 has been lowered from 6 to 3 (reference numeral 700). With this change, future data packets directed to VIP 1 will be more likely to be dropped by prioritization logic 222 as packet buffer memory 220 grows in usage size.

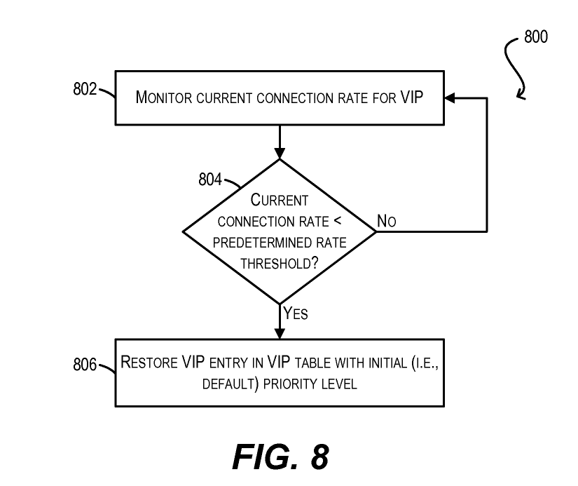

In some embodiments, once the priority level for a given VIP has been lowered per FIG. 6, the priority level can be restored again to its default value after the connection rate falls back below the predefined rate threshold. FIG. 8 depicts a flowchart 800 of such a process.

At block 802, a processing core 216(1)-216(N) can monitor the connection rate for a

VIP that has previously had its priority level lowered (e.g., VIP 1 shown in FIG. 7). At block 804, processing core 216(1)-216(N) can compare the current connection rate with VIP 1's predefined rate threshold.

If the current connection rate is below the predetermined rate threshold (indicating that the traffic for VIP 1 has return to a “normal” level), processing core 216(1)-216(N) can restore the entry for VIP 1 in VIP table 224 with VIP 1's default priority level (e.g., priority level 6). With this change, future data packets directed to the VIP 1 will be less likely to be dropped by prioritization logic 222. Otherwise, process 800 can return to block 802 and processing core 216(1)-216(N) can continue to monitor the connection rate for VIP 1.

The above description illustrates various embodiments of the present invention along with examples of how aspects of the present invention may be implemented. These examples and embodiments should not be deemed to be the only embodiments, and are presented to illustrate the flexibility and advantages of the present invention as defined by the following claims. For example, although the foregoing description focuses on performing prioritization based on the destination VIP of incoming data packets, it should be appreciated that the techniques described herein may also be used to prioritize data packets based on other criteria (e.g., other packet fields such as source address, HTTP hostname, URL, etc.). In these embodiments, the network switch may store associations between priority levels and data values that are appropriate for the chosen criterion (rather than associations between priority levels and VIPs as shown in FIG. 5).

As another example, rather than automatically dropping a data packet when it is determined that the current packet buffer memory usage has exceeded the packet buffer threshold, the network switch can alternatively perform a user-defined action (or sequence of actions) on the packet (e.g., drop, store in memory, etc.). In this way, the network switch can flexibly accommodate different types of workflows based on traffic priority.

As yet another example, although certain embodiments have been described with respect to particular process flows and steps, it should be apparent to those skilled in the art that the scope of the present invention is not strictly limited to the described flows and steps. Steps described as sequential may be executed in parallel, order of steps may be varied, and steps may be modified, combined, added, or omitted. As yet another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the invention as set forth in the following claims.

What is claimed is:

1. A method comprising:
determining, by a network device, a packet buffer threshold for a received data packet;
comparing, by the network device, the packet buffer threshold with a current usage of a packet buffer memory, the packet buffer memory storing data for data packets to be forwarded to a processing core of the network device; and
if the current usage exceeds the packet buffer threshold, performing, by the network device, an action on the received data packet.

2. The method of claim 1 wherein the action comprises dropping the received data packet.

3. The method of claim 1 further comprising:
if the current usage of the packet buffer memory does not exceed the packet buffer threshold, adding data for the received data packet to the packet buffer memory.

4. The method of claim 1 wherein determining the packet buffer threshold comprises:
retrieving a destination IP address included in the received data packet; and
identifying a virtual IP address (VIP) in a table of VIPs that matches the destination IP address.

5. The method of claim 4 wherein determining the packet buffer threshold further comprises:
determining, from the table, a priority level associated with the VIP; and
determining the packet buffer threshold based on the priority level.

6. The method of claim 5 further comprising:
detecting that the VIP is experiencing an abnormally high level of data traffic; and
in response to the detecting, lowering the packet buffer threshold.

7. The method of claim 6 wherein the detecting comprises:
monitoring, by the processing core, a current connection rate for the VIP; and
determining, by the processing core, that the current connection rate exceeds a predetermined connection rate threshold for the VIP.

8. The method of claim 6 wherein lowering the packet buffer threshold comprises:
assigning, by the processing core, a new priority level to the VIP, the new priority level having a lower packet buffer threshold; and
associating the new priority level with the VIP in the table of VIPs.

9. A network device comprising:
a general purpose processor;
a packet buffer memory for storing data for data packets to be forwarded to the general purpose processor; and
a buffer management component configurable to:
determine a packet buffer threshold for a received data packet;
compare the packet buffer threshold with a current usage of the packet buffer memory; and
if the current usage exceeds the packet buffer threshold, performing an action on the received data packet.

10. The network device of claim 9 wherein the action comprises dropping the received data packet.

11. The network device of claim 9 wherein determining the packet buffer threshold comprises:
retrieving a destination IP address included in the received data packet; and
identifying a virtual IP address (VIP) in a table of VIPs that matches the destination IP address.

12. The network device of claim 11 wherein determining the packet buffer threshold further comprises:
determining, from the table, a priority level associated with the VIP; and
determining the packet buffer threshold based on the priority level.

13. The network device of claim 12 wherein the buffer management component is further configurable to:
detect that the VIP is experiencing an abnormally high level of data traffic; and
in response to the detecting, lower the packet buffer threshold.

14. The network device of claim 13 wherein the detecting comprises:
monitoring, by the general purpose processor, a current connection rate for the VIP; and
determining, by the general purpose processor, that the current connection rate exceeds a predetermined connection rate threshold for the VIP.

15. The network device of claim 13 wherein lowering the packet buffer threshold comprises:
assigning, by the general purpose processor, a new priority level to the VIP, the new priority level having a lower packet buffer threshold; and
associating the new priority level with the VIP in the table of VIPs.

16. The network device of claim 9 wherein the network device is an application delivery controller (ADC).

17. The network device of claim 9 wherein the buffer management component is implemented as a field programmable gate array (FPGA).

18. A non-transitory computer readable medium having stored thereon program code executable by a buffer management component of a network device, the program code comprising:
code that causes the buffer management component to determine a packet buffer threshold for a received data packet;
code that causes the buffer management component to compare the packet buffer threshold with a current usage of a packet buffer memory, the packet buffer memory storing data for data packets to be forwarded to a processing core of the network device; and
code that causes the buffer management component to perform an action on the received data packet if the current usage exceeds the packet buffer threshold.

19. The non-transitory computer readable medium of claim 18 wherein the action comprises dropping the received data packet.

20. The non-transitory computer readable medium of claim 18 wherein the code that causes the buffer management component to determine the packet buffer threshold comprises:
code that causes the buffer management component to retrieve a destination IP address included in the received data packet; and
code that causes the buffer management component to identify a virtual IP address (VIP) in a table of VIPs that matches the destination IP address.

21. The non-transitory computer readable medium of claim 18 wherein the code that causes the buffer management component to determine the packet buffer threshold further comprises:
code that causes the buffer management component to determine, from the table, a priority level associated with the VIP; and
code that causes the buffer management component to determine the packet buffer threshold based on the priority level.

22. The non-transitory computer readable medium of claim 21 wherein the processing core is configurable to detect that the VIP is experiencing an abnormally high level of data traffic and, in response to the detecting, lower the packet buffer threshold.

23. The non-transitory computer readable medium of claim 22 wherein the processing core performs the detecting by:
monitoring a current connection rate for the VIP; and
determining that the current connection rate exceeds a predetermined connection rate threshold for the VIP.

24. The non-transitory computer readable medium of claim 22 wherein the processing core lowers the packet buffer threshold by:
assigning a new priority level to the VIP, the new priority level having a lower packet buffer threshold; and
associating the new priority level with the VIP in the table of VIPs.
